(19) United States
(12) Patent Application Publication
(10) Pub. No.: US 2007/0023345 A1
(43) Pub. Date: Feb. 1, 2007

(54) Emergency saltwater filtration system

(76) Inventor: Jerry Westmoreland, Cantonment, FL (US)

Correspondence Address: Jerry Westmoreland, 2131 FoxFord Street, Cantonment, FL, 32533, US

(21) Appl. No.: 11/362,981

(22) Filed: Feb. 24, 2006

Related U.S. Application Data
(60) Provisional application No. 60/595,737, filed on Aug. 1, 2005.

(51) Int. Cl. B01D 35/02; B01D 35/26

(52) U.S. Cl. 210/237; 210/241; 210/416.3

(57) ABSTRACT

The primary benefits provided by the Emergency Saltwater Filtration System includes, but not limited to, providing an unlimited fresh water supply while in a small boats. The Emergency Saltwater Filtration is compact, simple to use and discreet It can be installed onto any small boat. In coastal areas the unit can be stored at home and used when fresh water have been contaminated by sea water cause by high tides. It can save lives especially where hurricanes such as Katrina contaminate the water supply and no fresh water is available.

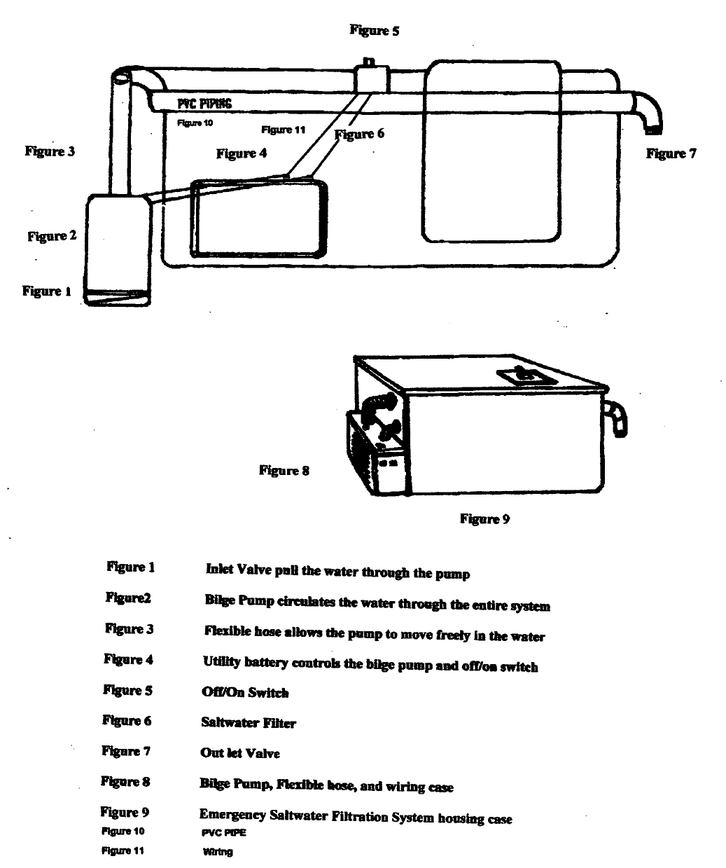

The invention is a device for small boats that removes the salt from seawater and converts the water into fresh drinkable water. The device is made of plastic with internal components to remove salt from seawater. It measures thirty inches in length by twenty-four inches in width. It contains a Bilge pump to pull the seawater through a flexible hose through a (PVC) pipe to the filter; the water is then free from salt. The water continues through the outlet valve. A utility battery powers the system.

The Emergency Saltwater Filtration System can filter out by a simple adding another filter to the system. The Emergency Saltwater Filtration System is run from direct current of the battery provided and/or the battery of the boat. The system can be stable in the boat or used as a portable unit.

The Saltwater Filtration System is designed for small boats. Its primary purpose is providing fresh drinkable water in cases of an emergency to ensure adequate water supply. Because the Emergency Saltwater Filtration System is portable it is good for coastal area where hurricanes are frequent, and drinkable is frequently contaminated. These systems can provide drinkable water when people are strained. The components specified for the Emergency Saltwater Filtration System utilizes standard production materials in technology currently used worldwide. The major components is a 12 volt bilge pump made of plastic compactable of delivering 500 gallon of water per hour. The pump contains a flexible hose so that the pump can move freely in the water. The pump is stored inside of a plastic case when not in use. The flexible hose from the pump connect to a (PVC) pipe (Plastic) inside of the case and run to the filter where salt is removed. A 12-volt utility battery powers the bilge pump and off/on switch. The material is readily available no new research or development in this area is expected nor is major retooling or increased material expense anticipated. The suffering of people in “Katrina” from the lack of water is within itself evident that the Emergency Saltwater Filtration System is greatly needed. Because no other system have been develop that can deliver fresh water to common people by portable means; where the individual can carry and operate the system without any problems. This was in evident after hurricane Katrina If the Emergency Saltwater Filtration System had patent and on the market after Katrina many of lives may have been saved from one unit.

What is claimed:

1. A device for small boats that remove the salt from sea water and converts the water into fresh drinkable water. The Emergency Saltwater Filtration functions by the utilization of a small pump to force sea water through a filter that eliminates the salt. A utility battery powers it. The Emergency Saltwater Filtration System is portable and can be used by common people in coastal area. The unit does not require fluids of any kind to force the water through the filter nor does it require sugar to assist in the process to produce drinkable water. The emergency Saltwater Filtration System contains a battery and off/on switch that allows the water to flow anywhere at the rate of 500 gallons per hour. This system is develop so that the average person would be able to operate it without complications. Simply place the pump in water and turn on the switch. The Emergency Saltwater Filtration System measures thirty (30) inches in length and twenty-four (24) inches in width. Outside of the case contains housing for the bilge pump that connects to a flexible hose that goes inside of the case and connects to a (PVC) pipe that connects to the filter housing where saltwater and/or seawater is filter. The design of the Emergency Saltwater Filtration System allows the unit to be used at sea as well as on land.
